(19) United States
(12) Patent Application Publication
(10) Pub. No.: US 2025/0041974 A1
(43) Pub. Date: Feb. 6, 2025

(54) METHOD FOR SEPARATING A WORKPIECE

(71) Applicant: TRUMPF Laser- und Systemtechnik GmbH, Ditzingen (DE)

(72) Inventors: Myriam Kaiser, Heimsheim (DE); Daniel Flamm, Ludwigsburg (DE); Jonas Kleiner, Leonberg (DE); Christian Schmitt, Buggingen (DE); Adam Hess, Denzlingen (DE); Bernd Uwe Sander, Freiburg (DE)

(21) Appl. No.: 18/923,740

(22) Filed: Oct. 23, 2024

Related U.S. Application Data
(63) Continuation of application No. PCT/EP2023/061010, filed on Apr. 26, 2023.

(30) Foreign Application Priority Data
Apr. 28, 2022 (DE) 10 2022 110 353.6

(51) Int. Cl. B23K 26/362; B23K 26/0622; B23K 26/067; B23K 26/38; B23K 103/00

(52) U.S. Cl. CPC B23K 26/362; B23K 26/0622; B23K 26/067; B23K 26/38; B23K 2103/54

(57) ABSTRACT

A method for severing a workpiece having a transparent material includes providing multiple focus elements using an input laser beam, applying the multiple focus elements to the material, thereby forming material modifications in the material along a predetermined processing line, and severing the material along the processing line by an etching process using a wet chemical solution. A temperature of the wet chemical solution during the etching process is at least 100° C. and/or at most 150° C.

### CROSS REFERENCE TO RELATED APPLICATIONS

This application is a continuation of International Application No. PCT/EP2023/061010 (WO 2023/209034 A1), filed on Apr. 26, 2023, and claims benefit to German Patent Application No. DE 10 2022 110 353.6, filed on Apr. 28, 2022. The aforementioned applications are hereby incorporated by reference herein.

### FIELD

Embodiments of the present invention relate to a method for severing a workpiece having a transparent material.

### BACKGROUND

DE 10 2019 218 995 A1 discloses a method for modifying by laser beam a material that is at least largely transparent to the laser beam, a focal zone of a single pulse of the laser beam that is elongated in the beam propagation direction being made to interact with the material and the interaction of the single pulse with the material creating a channel that passes through the material from a first end face to a second end face and has a channel width dimension of at most 1 μm.

A method for severing a transparent material using an elongated focal zone of a laser beam is known from EP 3 597 353 A1.

A method for severing a transparent material using multiple parallel nondiffracting laser beams is known from WO 2016/089799 A1.

A method for severing and in particular beveling a transparent material is known from JP 2020 004 889 A, wherein a plurality of focal points for laser processing the material are generated using a spatial light modulator.

Methods for forming a beveled edge region on a transparent material using a laser beam are known from US 2020/0147729 A1 and US 2020/0361037 A1.

DE 10 2018 110 211 A1 discloses a method for creating a cavity in a substrate made of hard brittle material, preferably glass or glass ceramic, wherein a laser beam is used to create a filament-shaped flaw in the volume of the substrate and wherein the substrate is exposed to an etching medium which removes material from the substrate at a removal rate of between 2 μm and 20 μm per hour.

WO 2017/062798 A1 discloses a method for forming vias in a glass-based substrate, wherein a plurality of etch paths are created and etching is carried out along the etch paths using a hydroxide-based etching material, wherein an etching rate along the etch paths is at least 12 times greater than an etching rate outside the etch paths.

WO 2018/162385 A1 discloses a method for introducing at least one recess into a transparent or transmissive material, wherein the material is selectively modified along a beam axis using electromagnetic radiation and the recesses are subsequently produced by one or more etching steps, wherein different etching rates occur in modified and unmodified regions.

### SUMMARY

Embodiments of the present invention provide a method for severing a workpiece having a transparent material. The method includes providing multiple focus elements using an input laser beam, applying the multiple focus elements to the material, thereby forming material modifications in the material along a predetermined processing line, and severing the material along the processing line by an etching process using a wet chemical solution. A temperature of the wet chemical solution during the etching process is at least 100° C. and/or at most 150° C.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1 shows a schematic illustration of one exemplary embodiment of a device for laser processing of a workpiece;

FIG. 2 shows a schematic cross-sectional representation of a portion of a material of the workpiece in which the material is severed along a machining line, according to some embodiments;

FIG. 3 shows a schematic cross-sectional representation of the portion according to FIG. 2, wherein multiple focus elements are applied to the material to form material modifications, according to some embodiments;

FIG. 4 shows a schematic cross-sectional representation of a portion of the material in which material modifications accompanied by crack formation in the material are produced by applying focus elements to the material, according to some embodiments;

FIG. 5 shows a cross-sectional representation of a simulated intensity distribution of focus elements for laser processing of the workpiece, according to some embodiments;

FIG. 6a shows a schematic perspective representation of a workpiece with material modifications formed thereon, wherein the workpiece is arranged in an etching bath for carrying out an etching process, according to some embodiments; and

FIG. 6b shows a schematic perspective representation of two workpiece segments formed by severing the workpiece according to FIG. 6a, according to some embodiments.

### DETAILED DESCRIPTION

Embodiments of the invention provide a method as mentioned above which enables the workpiece to be severed at a higher speed and/or in a shorter time.

According to embodiments of the invention, multiple focus elements are provided using an input laser beam, the focus elements are applied to the material, material modifications are formed in the material along a predetermined processing line by applying the focus elements to the material, and the material is severed along the processing line by an etching process using a wet chemical solution, wherein a temperature of the wet chemical solution during the etching process is at least 100° C. and/or at most 150° C.

Since the temperature of the wet chemical solution during the etching process is in the stated range, the material can be etched at a high etching rate at the material modifications arranged along the processing line, the etching rate outside the material modifications being lower than the etching rate at the material modifications along the processing line. This enables selective etching with a high etching rate at the material modifications along the processing line. This results in the shorter duration for the etching process for severing the material along the processing line. The method can therefore be carried out at an increased speed.

In particular, the etching process for severing the material is carried out after the focus elements have been applied to the material and/or after the material modifications have been formed along the processing line.

By applying the focus elements to the material of the workpiece, material modifications are formed which are arranged in the material at positions and/or spacings corresponding to the focus elements. In particular, the spacing of the mutually adjacent focus elements corresponds to the spacing of mutually adjacent material modifications formed in the material of the workpiece using these focus elements. However, it is also fundamentally possible for multiple material modifications and/or elongate material modifications to be formed using a focus element, for example if the focus element has a Bessel-like shape.

In particular, the focus elements arranged along the processing line are spaced apart and/or have such an intensity that the material modifications formed along the processing line using the focus elements enable the material to be severed by etching using the wet chemical solution.

In particular, the focus elements provided are each arranged at different spatial positions in the material. The spatial position of a given focus element is to be understood in particular to mean a center point position of the corresponding focus element.

The fact that the at least one input laser beam provides multiple focus elements can be understood in particular to mean that the focus elements are provided simultaneously. However, it can also be understood to mean that one or more focus elements are provided at different times, i.e., that, for example, at a given point in time at least one focus element is available for laser processing of the workpiece at a given position and at another point in time at least one further focus element is available for laser processing of the workpiece at a different position.

It may be advantageous for the wet chemical solution to be an aqueous KOH solution with a concentration of at least 15 wt. % and/or at most 50 wt. %. This allows selective etching of the material at the material modifications positioned along the processing line.

For the same reason, it may be advantageous for the wet chemical solution to be an aqueous NaOH solution with a concentration of at least 15 wt. % and/or at most 50 wt. %.

In particular, provision may be made for the temperature of the wet chemical solution to be kept constant over time during the etching process. This makes it possible to achieve selective etching with an at least approximately constant etching rate. This also allows the etching process to be carried out in as controlled a manner as possible.

In particular, the temperature is selected such that the etching rate of the material at the material modifications is maximized and the wet chemical solution does not evaporate or only evaporates insignificantly. In the case of a KOH or NaOH solution, for example, the boiling temperature of the wet chemical solution depends on the corresponding KOH or NaOH concentration.

The fact that the temperature of the wet chemical solution is kept constant over time should in particular be understood to mean that the actual temperature of the wet chemical solution during the etching process deviates from the specified (constant over time) temperature or setpoint temperature by less than the difference values mentioned in the following paragraph.

In particular, the temperature is adjusted to a setpoint temperature, constant over time, of at least 100° C. and/or at most 150° C., wherein an actual temperature of the wet chemical solution during the etching process deviates from the setpoint temperature by less than 7 K and in particular less than 5 K and in particular less than 3 K and in particular less than 1 K.

In particular, provision may be made for the wet chemical solution to be an aqueous KOH solution or an aqueous NaOH solution, wherein a concentration of the solution is selected such that a boiling temperature of the solution is at least 5% and in particular at least 10% and in particular at least 15% higher than a setpoint temperature, constant over time, of the wet chemical solution during the etching process.

For example, the etching process has a duration of at least 5 minutes and/or at most 180 minutes and preferably at least 10 minutes and/or at most 90 minutes.

In particular, provision may be made for the wet chemical solution to be applied to the material in order to carry out the etching process. In particular, the wet chemical solution is partially or completely applied to the material. In particular, the material is partially or completely introduced into the wet chemical solution. In particular, the material is then partially or completely surrounded by the wet chemical solution.

Provision may be made for the etching process to be carried out with ultrasound assistance. For example, the etching process is carried out in an ultrasound-assisted etching bath. This simplifies material severing, in particular. In addition, this allows the speed of the etching process to be further increased.

Provision may be made for mechanical stress and/or force to be additionally applied to the material for severing purposes, and/or for heat to be additionally applied to the material for severing purposes. This makes it possible in particular to achieve optimized severing of the material.

It may be advantageous for mutually adjacent focus elements to be spaced by at least 3 μm and/or at most 70 μm and preferably at least 5 μm and/or at most 10 μm. This allows the etching process at the material modifications formed using the focus elements to be carried out selectively at a high etching rate.

For the same reason, it may be advantageous for mutually adjacent material modifications to be spaced by at least 3 μm and/or at most 70 μm and preferably at least 5 μm and/or at most 10 μm. The spacing in the specified value ranges between the mutually adjacent material modifications refers to a spacing direction which is oriented parallel to a feed direction in which the focus elements are moved relative to the material during laser processing of the material, and/or to a spacing direction which lies in a plane oriented perpendicular to the feed direction. In particular, the spacing refers to a spacing direction that lies in a processing surface at which material modifications are arranged.

It may be advantageous for the input laser beam and/or a laser beam from which the focus elements are formed to be a pulsed laser beam and in particular an ultrashort pulse laser beam. By applying the focus elements to the material, in particular laser pulses and in particular ultrashort laser pulses are thereby introduced into the material. This makes it possible, for example, to form type III material modifications in the material, which enable severing of the material.

For the same reason, it may be advantageous for a given focus element to be assigned a pulse energy of at least 0.5 μJ and/or at most 10 μJ, and preferably of at least 1 μJ and/or at most 5 μJ.

For example, a wavelength of the input laser beam and/or of the laser beam from which the focus elements are formed is at least 300 nm and/or at most 1500 nm. For example, the wavelength is 515 nm or 1030 nm.

In particular, the input laser beam and/or the laser beam from which the focus elements are formed has an average power of at least 1 W to 1 kW. For example, the laser beam comprises pulses having a pulse energy of at least 10 μJ and/or at most 50 μJ. Provision may be made for the laser beam to comprise single pulses or bursts, wherein the bursts have 2 to 20 sub-pulses and in particular a time interval of approximately 20 ns.

In particular, the input laser beam and/or a laser beam from which the focus elements are formed has a diffracting beam profile and/or a Gaussian beam profile.

In particular, the focus elements have a diffracting beam profile and/or are of diffraction-limited configuration. For example, one or more focus elements has/have a Gaussian shape and/or a Gaussian intensity profile.

It is fundamentally also possible for one or more focus elements to have a Bessel-like shape and/or a quasi-non-diffracting intensity profile and/or a Bessel-like intensity profile. For example, a Bessel-like beam profile is then assigned to the input laser beam.

The focus elements provided to form the material modifications along the processing line may, but do not necessarily have to, have the same shape and/or intensity profile.

It may be advantageous for the input laser beam to be split into a plurality of sub-beams using a beam splitting element and for the focus elements to be formed by focusing sub-beams coupled out of the beam splitting element. The focus elements may thereby be formed, for example, as copies of one another. In particular, the focus elements may thereby be introduced in a technically simple manner at different positions and/or with different spacings into the material of the workpiece.

For the same reason, it may be advantageous for splitting of the input laser beam using the beam splitting element to be performed by phase imprinting onto a beam cross-section of the input laser beam or to comprise phase imprinting onto a beam cross-section of the input laser beam.

The beam splitting element preferably takes the form of a 3D beam splitting element or comprises a 3D beam splitting element.

For example, the beam splitting element comprises multiple components and/or functionalities. Provision may be made for the beam splitting element to comprise both a 3D beam splitting element and a polarization beam splitting element.

Provision may be made for splitting of the input laser beam to be performed solely by phase imprinting onto the beam cross-section of the input laser beam.

In particular, the phase imprinting takes place in the transverse direction of the input laser beam. The transverse direction lies in a plane oriented perpendicular to the direction of beam propagation of the input laser beam.

Alternatively or additionally, provision may be made for splitting of the input laser beam using the beam splitting element to be performed by polarization beam splitting or to comprise polarization beam splitting. For example, mutually adjacent focus elements may then each be formed with different polarization states. In particular interference of mutually adjacent focus elements can thus be prevented. Mutually adjacent focus elements may thus be arranged, for example, at a small spacing from one another.

It is fundamentally possible for splitting of the input laser beam to be performed both by phase imprinting and by polarization beam splitting.

In particular, provision may be made for the processing line to be formed spatially continuously over a thickness of the material of the workpiece and/or over a thickness of a workpiece segment to be detached from the workpiece. This makes it possible, for example, to divide the workpiece into two parts or to detach a workpiece segment from the workpiece.

In particular, the processing line extends from an outer side of the workpiece to an inner region of the material.

An outer side of the workpiece is understood to mean in particular an outer side of the material of the workpiece. The focus elements are introduced into this material.

For example, the processing line extends in particular spatially continuously from a first outer side of the workpiece, through which the focus elements and/or a laser beam are coupled into the material to form the focus elements, to a second outer side of the workpiece spaced apart in the thickness direction of the workpiece.

In particular, material modifications and/or cracks are in each case assigned to the processing line which extend from an inner region of the material to an outer side of the workpiece. This makes it possible to couple wet chemical solution at the outer side into these material modifications or cracks of the processing line.

In particular, a shape of the processing line corresponds to a shape and/or cross-sectional shape and in particular to a desired shape and/or desired cross-sectional shape of a parting surface formed or to be formed by severing the material. Thus, by means of the processing line, an edge geometry and/or a cross-sectional geometry and in particular a desired edge geometry and/or desired cross-sectional geometry of a parting surface resulting from severing of the material can be defined.

For example, the at least one processing line has a total length of between 50 μm and 5000 μm and preferably between 100 μm and 1000 μm. Workpieces having a thickness in the stated range may thus be processed and in particular severed.

The material of the workpiece has, for example, a thickness of between 50 μm and 5000 μm and preferably between 100 μm and 1000 μm, for example approximately 500 μm.

The processing line is not necessarily of spatially contiguous configuration, but rather may have different, spatially separated sections. In particular, the processing line can have gaps and/or interruptions at which no focus elements are arranged.

In particular, the processing line corresponds to a connecting line between mutually adjacent focus elements within the material.

In particular, provision may be made for the processing line to be a straight line at least in places, and/or for the processing line to be curved at least in places and/or to be a curve.

By embodying the processing line as a curve, for example, rounded segments may be detached from the workpiece. For example, rounded edges may thus be created.

If the processing line is embodied as a curve, the processing line is, for example, assigned a specific angle of attack range, which the processing line exhibits with respect to an outer side of the workpiece.

In particular, provision may be made for the spacing between the mutually adjacent focus elements to have a nonzero spacing component, which is oriented parallel to a thickness direction of the workpiece. In particular, the respective spacing of all adjacent focus elements which are provided for laser processing of the workpiece has a nonzero spacing component which is oriented parallel to the thickness direction of the workpiece.

The thickness direction of the workpiece is to be understood in particular to mean a direction which is oriented transversely of and in particular perpendicular to an outer side of the workpiece through which the focus elements and/or a laser beam for forming the focus elements are coupled into the material.

In particular, the spacing component parallel to the thickness direction has a value which is greater than zero in terms of amount.

An adjacent focus element is understood to mean in particular a closest neighbor of a given focus element.

In particular, provision may be made for the spacing of the mutually adjacent focus elements to have a nonzero spacing component which is oriented parallel to a beam propagation direction of a laser beam from which the focus elements are formed. In particular, the respective spacing between all adjacent focus elements which are provided for laser processing of the workpiece has this nonzero spacing component.

In particular, provision may be made for an angle of attack between the processing line and an outer side of the workpiece through which the focus elements are coupled into the material of the workpiece to be at least 1° and/or at most 90°, at least in places. Depending on the selected angle of attack, perpendicular severing of the workpiece may thereby be carried out, for example, or the workpiece may be chamfered at a specific angle.

The processing line having a specific angle of attack or angle of attack range at least in places is to be understood in particular to mean that the processing line has at least one portion with this angle of attack or angle of attack range.

In particular, the angle of attack can be at least 10° and/or at most 80°, preferably at least 30° and/or at most 60°, preferably at least 40° and/or at most 50°.

In particular, provision may be made for the angle of attack of the processing line to be constant at least in places, and/or for the processing line to have multiple portions with different angles of attack.

The material modifications introduced into transparent materials by ultrashort laser pulses are subdivided into three different classes, see K. Itoh et al. “Ultrafast Processes for Bulk Modification of Transparent Materials” MRS Bulletin, vol. 31, p. 620 (2006): type I is an isotropic refractive index change; type II is a birefringent refractive index change; and type III is a “void” or cavity. In this respect, the material modification created depends on laser parameters of the laser beam from which the focus element is formed, such as e.g. the pulse duration, wavelength, pulse energy and repetition rate of the laser beam, and on the material properties, such as, among other things, the electronic structure and coefficient of thermal expansion, and also on the numerical aperture (NA) of the focusing.

Type I isotropic refractive index changes are attributed to spatially restricted fusing by the laser pulses and fast resolidification of the transparent material. For example, quartz glass has a higher material density and refractive index if the quartz glass is cooled down quickly from a higher temperature. Thus, if the material in the focus volume melts and then cools rapidly, the quartz glass has a higher refractive index in the regions of material modification than in the unmodified regions.

Type II birefringent refractive index changes may arise, for example, due to interference between the ultrashort laser pulse and the electric field of the plasma generated by the laser pulses. This interference leads to periodic modulations in the electron plasma density, which upon solidification leads to a birefringent property, that is to say direction-dependent refractive indices, of the transparent material. Type II modification is, for example, also accompanied by the formation of “nanogratings.”

The voids (cavities) of type III modifications may, for example, be generated with a high laser pulse energy. Formation of the voids is in this case attributed to an explosive expansion of highly excited, vaporized material from the focus volume into the surrounding material. This process is also designated microexplosion. Since this expansion occurs within the mass of the material, the microexplosion leaves behind a less dense or hollow core (the void), or a microscopic defect in the sub-micrometer range or in the atomic range, which void or defect is surrounded by a compacted material envelope. Compaction at the shock front of the microexplosion creates stresses in the transparent material, which may lead to spontaneous crack formation or may promote crack formation.

In particular, the formation of voids may also be accompanied by type I and type II modifications. By way of example, type I and type II modifications may arise in the less stressed areas around the introduced laser pulses. Accordingly, whenever reference is made to the introduction of a type III modification, a less dense or hollow core or a defect is present. By way of example, in the case of a type III modification in sapphire, a region of lower density rather than a void is produced by the microexplosion. Due to the material stresses arising in the case of a type III modification, such a modification is often also accompanied by, or at least promotes, crack formation. The formation of type I and type II modifications cannot be fully prevented or avoided when introducing type III modifications. It is therefore unlikely that “pure” type III modifications are to be found.

At high repetition rates of the laser beam, the material cannot cool down completely between the pulses, such that cumulative effects of the heat introduced from pulse to pulse can influence the material modification. By way of example, the repetition rate of the laser beam can be higher than the reciprocal of the thermal diffusion time of the material, such that heat accumulation may occur in the focus elements as a result of successive absorption of laser energy until the melting temperature of the material has been reached. Moreover, a region larger than the focus elements may be fused by the thermal transfer of heat energy into the areas surrounding the focus elements. The heated material cools quickly following the introduction of ultrashort laser pulses, such that the density and other structural properties of the high-temperature state are, as it were, frozen in the material.

It may be advantageous for material modifications to be formed in the material by applying the focus elements to the material, wherein the material modifications are type III material modifications and/or wherein the material modifications are accompanied by crack formation in the material. In particular, these material modifications may be used to sever the material by etching and in particular selective etching.

In particular, provision may be made for the focus elements to be moved in a feed direction relative to the material of the workpiece. The focus elements preferably lie at least approximately in a plane oriented in particular perpendicular to the feed direction.

Due to the movement of the focus elements relative to the material of the workpiece, a processing surface corresponding to the processing line is formed, along which material modifications are arranged and/or along which the material of the workpiece can be severed.

In particular, the workpiece is divided into two or more workpiece segments during severing thereof or at least one workpiece segment is detached from the workpiece during severing thereof.

A workpiece segment formed by severing of the workpiece can be a useful segment and/or yield segment, which in particular has a parting surface that has a shape corresponding to a shape of the processing line and/or processing surface. Furthermore, a workpiece segment formed by severing the workpiece can be a scrap segment and/or waste segment.

In particular, by severing the workpiece along the processing surface, a workpiece segment is created with a parting surface whose geometry corresponds to the processing surface.

A transparent material is understood to mean, in particular, a material that is transparent to the input laser beam and/or a laser beam from which the focus elements are formed. In particular, it is understood to mean a material which transmits at least 70% and in particular at least 80% and in particular at least 90% of the laser energy of the input laser beam and/or the laser beam from which the focus elements are formed.

In particular, a focus element is understood to mean a focused radiation region of the input laser beam, which in particular has a given spatial extent and/or which in particular is spatially contiguous. To determine spatial dimensions of a given focus element, such as a diameter of the focus element, only intensity values above a given intensity threshold are considered. In this respect, the intensity threshold is selected, for example, such that values below this intensity threshold have such a low intensity that they are no longer relevant for interaction with the material for the purpose of forming material modifications. For example, the intensity threshold amounts to 50% of a global intensity maximum of the focus element.

In particular, a given focus element is assigned a respective spatial region of interaction, in which the focus element interacts with the material of the workpiece when it is introduced into this material.

In particular, the focus elements introduced into the material interact with the material through nonlinear absorption, i.e., the laser radiation assigned to the focus elements interacts with the material through nonlinear absorption. In particular, it is as a result of this interaction between the focus elements and the material that the material modifications are formed in the material.

Provision may in particular be made for the respective focus elements according to the preceding definition to have a maximum spatial extent of at least 0.5 μm and/or at most 60 μm, preferably at least 2 μm and/or at most 10 μm. In particular, a maximum spatial extent of a region of interaction, assigned to a given focus element, with the material of the workpiece amounts to at least 0.5 μm and/or at most 60 μm, and preferably at least 2 μm and/or at most 10 μm.

The maximum spatial extent of a given focus element is to be understood in particular to mean the greatest spatial extent of the focus element in an arbitrary spatial direction.

In particular, the statements “at least approximately” or “approximately” should be understood to mean in general a deviation of at most 10%. Unless stated otherwise, the statements “at least approximately” or “approximately” are to be understood to mean in particular that an actual value and/or spacing and/or angle deviates by no more than 10% from an ideal value and/or spacing and/or angle.

Elements that are the same or have equivalent functions are provided with the same reference signs in all of the figures.

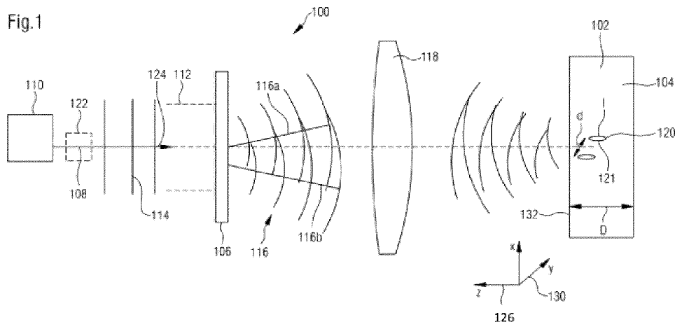

One exemplary embodiment of a device for laser processing of a workpiece is shown in FIG. 1 and designated 100 therein. Localized material modifications, such as defects in the sub-micrometer range or atomic range, which result in material weakening, may be produced in a material 102 of the workpiece 104 using the device 100. The workpiece 104 can be severed at these material modifications. By way of example, a workpiece segment can be detached from the workpiece 104 using the material modifications formed.

In particular, material modifications may be introduced into the material 102 at an angle of attack using the device 100, such that an edge region of the workpiece 104 may be chamfered or beveled by detaching a corresponding workpiece segment from the workpiece 104.

The device comprises a beam splitting element 106, into which an input laser beam 108 is coupled. This input laser beam 108 is provided, for example, by a laser source 110. The input laser beam 108 is, for example, a pulsed laser beam and/or an ultrashort pulse laser beam.

In particular, the input laser beam 108 is to be understood to mean a beam bundle comprising a plurality of beams extending in particular in parallel. The input laser beam 108 in particular has a transverse beam cross-section 112 and/or a transverse beam extent with which the input laser beam 108 impinges on the beam splitting element 106.

The input laser beam 108 incident on the beam splitting element 106 in particular has at least approximately planar wavefronts 114.

The input laser beam 108 is split by the beam splitting element 106 into a plurality of sub-beams 116 and/or sub-beam bundles. In the example shown in FIG. 1, two different sub-beams 116a and 116b are indicated.

The sub-beams 116 or sub-beam bundles coupled out of the beam splitting element 106 in particular have a divergent beam profile. In particular, the beam splitting element 106 takes the form of a far field beam forming element.

To focus the sub-beams 116 coupled out of the beam splitting element 106, the device 100 comprises a focusing optical unit 118, into which the sub-beams 116 are coupled. In particular, different sub-beams 116 impinge on the focusing optical unit 118 with a position offset and/or angular offset.

The focusing optical unit 118 has one or more lens elements, for example. By way of example, the focusing optical unit 118 takes the form of a microscope objective. The focusing optical unit 118 has, for example, a focal length between 5 mm and 50 mm.

For example, the beam splitting element 106 is at least approximately arranged in a rear focal plane of the focusing optical unit 118.

The sub-beams 116 are focused using the focusing optical unit 118, such that multiple focus elements 120 are formed which are each arranged at different spatial positions. It is fundamentally possible for different and/or mutually adjacent focus elements to overlap spatially in places.

For example, one or more sub-beams 116 and/or sub-beam bundles are each assigned to a given focus element 120. For example, a respective focus element 120 is formed by focusing one or more sub-beams 116 and/or sub-beam bundles.

A focus element 120 is to be understood in particular to mean a focused radiation area, such as a focus spot, a focus point or a focus line for example. In particular, the focus elements 120 each have a given geometric shape and/or a given intensity profile, wherein the geometric shape is to be understood, for example, to mean a spatial shape and/or a spatial extent of the respective focus element 120.

The geometric shape and/or the intensity profile of a given focus element 120 is designated hereinafter as the focus distribution 121 of the focus element 120. The focus distribution 121 is a property of the respective focus elements 120 and describes their shape and/or intensity profile. In particular, multiple focus elements 120 or all focus elements 120 formed have the same focus distribution.

The focus distribution of the focus elements 120 formed is defined by the input laser beam 108, the splitting of which using the beam splitting element 106 forms the focus elements 120. If the input laser beam 108 were focused before being coupled into the beam splitting element 106, a single focus element would thus be formed with the focus distribution assigned to the input laser beam 108.

For example, the input laser beam 108, if it is provided, for example, using the laser source 110, has a Gaussian beam profile. By focusing the input laser beam 108, a focus element would be formed in this case which has a focus distribution with a Gaussian shape and/or Gaussian intensity profile.

Alternatively, provision may for example be made for a quasi-non-diffracting and/or Bessel-like beam profile to be assigned to the input laser beam 108, such that by focusing the input laser beam 108, a focus element would be formed which has a focus distribution with a quasi-non-diffracting or Bessel-like shape and/or quasi-non-diffracting or Bessel-like intensity profile.

The focus distribution of the input laser beam 108 is assigned to the sub-beams 116 and/or sub-beam bundles formed by splitting the input laser beam 108 using the beam splitting element 106 such that by focusing the sub-beams 116, the focus elements 120 are formed with this focus distribution and/or with a focus distribution based on this focus distribution.

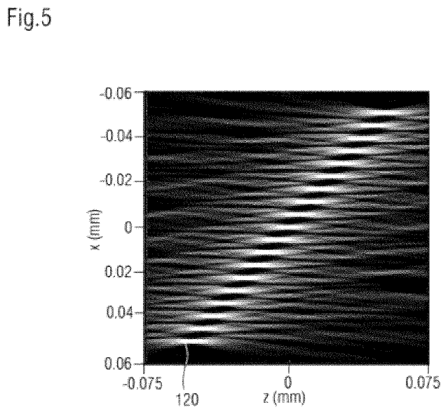

In the example shown in FIG. 1, the input laser beam 108 has a Gaussian beam profile, i.e., a focus distribution with a Gaussian shape and/or Gaussian intensity profile is assigned to the input laser beam 108. The focus elements 120 then each, for example, have the focus distribution 121 having this Gaussian shape and/or this Gaussian intensity profile or having a shape or intensity profile respectively based on this Gaussian shape and/or this Gaussian intensity profile (cf. FIG. 5).

If, for example, a Bessel-like beam profile is assigned to the input laser beam 108, the focus elements 120 formed for laser processing of the workpiece 104 each have a focus distribution 121 having this Bessel-like beam profile or having a beam profile based on this Bessel-like beam profile. The focus elements 120 may thus each be formed, for example, with a focus distribution that has an elongate shape and/or an elongate intensity profile.

Provision may be made for the device 100 to have a beam forming means 122 for beam forming of the input laser beam 108 (indicated in FIG. 1). For example, this beam forming means 122 is arranged upstream of the beam splitting element 106 and/or between the laser source 110 and the beam splitting element 106 with respect to a beam propagation direction 124 of the input laser beam 108.

A beam propagation direction is to be understood in particular to mean a main beam propagation direction and/or an average propagation direction of laser beams.

A given focus distribution and/or a given beam profile may be assigned in particular to the input laser beam 108 by the beam forming device 122. In particular, the focus distribution 121 of the focus elements 120 may be defined using the beam forming device 122.

The beam forming device 122 can be configured, for example, to form a laser beam with a quasi-non-diffracting and/or Bessel-like beam profile from a laser beam with a Gaussian beam profile. The input laser beam 108 coupled into the beam splitting element 106 is then assigned the quasi-non-diffracting and/or Bessel-like beam profile. Accordingly, the focus elements 120 are then formed with this quasi-non-diffracting and/or Bessel-like beam profile or with a beam profile based on this beam profile.

For example, the beam forming means 122 may comprise an axicon element for forming laser beams with a quasi-non-diffracting and/or Bessel-like beam profile. To couple beams coupled out of the beam forming means 122 into the beam splitting element 106, one or more lens elements may then, for example, be provided (not shown).

With regard to the definition and implementation of quasi-non-diffracting and/or Bessel-like beams, reference is made to the book: “Structured Light Fields: Applications in Optical Trapping, Manipulation and Organisation”, M. Wördemann, Springer Science & Business Media (2012), ISBN 978-3-642-29322-1 and also to the scientific publications “Bessel-like optical beams with arbitrary trajectories” by I Chremmos et al., Optics Letters, Vol. 37, No. 23, 1 Dec. 2012 and “Generalized axicon-based generation of nondiffracting beams” by K. Chen et al., arXiv: 1911.03103v1 [physics.optics], Nov. 8, 2019.

The focus elements 120 are in particular each of mutually identical configuration and/or each configured as copies of one another by beam splitting using the beam splitting element 106.

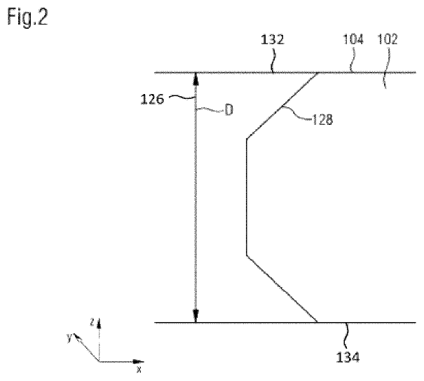

A schematic cross-section of the workpiece 104 and the material 102 is shown in FIGS. 2 to 4, wherein a cross-sectional plane is oriented parallel to a thickness direction 126 and/or depth direction of the workpiece (in the example shown, the thickness direction 126 is oriented parallel to the z-direction).

Provision is made for the workpiece 104 to be severed along a predefined processing line 128 once laser processing using the device 100 has been completed. The processing line 128 corresponds to a cross-sectional geometry with which the workpiece 104 is to be severed.

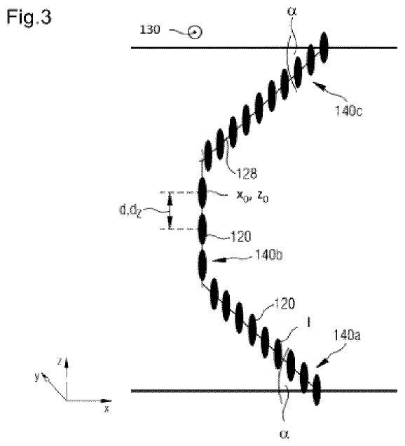

To carry out the laser processing, the focus elements 120 are introduced into the material 102 of the workpiece 104 (FIG. 3). Provision is made for the focus elements 120 introduced into the material 102 of the workpiece 104 to be moved relative to the material 102 in a feed direction 130. Movement of the focus elements 120 relative to the material 102 takes place in the feed direction 130, in particular at a defined feed speed.

A given spatial position x₀, z₀, at which a respective focus element 120 is arranged with respect to the material 102 of the workpiece 104, is assigned to each of the focus elements 120 formed. For example, the spatial position of a focus element 120 is to be understood to mean the position of its spatial center point and/or focal point.

In particular, the spatial positions x₀, z₀ of the respective focus elements 120 lie in a plane oriented perpendicular to the feed direction 130, wherein in particular all the focus elements 120 formed for laser processing of the workpiece 104 lie in this plane.

Furthermore, a given intensity I is in particular assigned to each of the focus elements 120 formed.

The spatial position x₀, z₀ and in particular also the intensity I of the respective focus elements 120 may be adjusted using the beam splitting element 106.

In particular, a respective spacing d and/or a respective position offset between mutually adjacent focus elements 120 can be set using the beam splitting element 106. A spacing direction of the spacing d adjustable using the beam splitting element 106 preferably lies in a plane which is oriented transversely of and in particular perpendicular to the feed direction 130. For example, the spacing d is settable using the beam splitting element 106 component-wise in two spatial directions, which form said plane or lie in said plane (x direction and z direction in the example shown in FIG. 3).

The feed direction 130 is oriented transversely of and in particular perpendicular to the thickness direction 126 of the workpiece 104.

The beam splitting element 106 preferably takes the form of a 3D beam splitting element or comprises a 3D beam splitting element. The focus elements 120 may thus be formed, for example, such that they are each identical to one another and/or that they each constitute copies of one another.

With respect to the technical implementation and properties of the beam splitting element 106 embodied as a 3D beam splitting element, reference is made to the scientific publication “Structured light for ultrafast laser micro- and nanoprocessing” by D. Flamm et al., arXiv: 2012.10119v1 [physics.optics], Dec. 18, 2020.

To carry out the beam splitting, in one embodiment of the beam splitting element 106, in which the beam splitting element 106 is embodied, for example, as a 3D beam splitting element, a defined transverse phase distribution is imprinted onto the transverse beam cross-section 112 of the input laser beam 108. A transverse beam cross-section or a transverse phase distribution is to be understood in particular to mean a beam cross-section or a phase distribution in a plane oriented transversely of and in particular perpendicular to the beam propagation direction 124 of the input laser beam 108.

The mutually spaced focus elements 120 are formed by interference of the focused sub-beams 116, wherein, for example, constructive interference, destructive interference, or intermediate cases thereof can occur, such as partially constructive or partially destructive interference.

To form the focus elements 120 at the respective position x₀, z₀ and/or with the respective spacing d, the phase distribution imprinted using the beam splitting element 106 has a specific optical grating component and/or optical lens component for each focus element 120.

Due to the optical grating component, after focusing of the sub-beams 116, a corresponding position offset of the focus elements 120 formed results in a first spatial direction, for example in the x direction. Due to the optical lens component, sub-beams 116 or sub-beam bundles impinge at different angles or with different convergence or divergence on the focusing optical unit 118, which results after completed focusing in a position offset in a second spatial direction, for example in the z direction.

The spatial positions x₀, z₀ can therefore be defined by appropriate design of the beam splitting element 106 or the phase distribution imprinted by the beam splitting element.

The intensity I of the respective focus elements 120 is determined by phasing of the focused sub-beams 116 relative to one another. This phasing is definable by said optical grating components and optical lens components. The phasing of the focused sub-beams 116 relative to one another can be selected, when designing the beam splitting element 106, in such a way that the focus elements 120 each have a desired intensity.

Alternatively or in addition to the variants of the beam splitting element 106 described above, provision may be made for the beam splitting element 106 to take the form of a polarization beam splitting element or to comprise a polarization beam splitting element. In this case, polarization beam splitting of the input laser beam 108 into beams which each have one of at least two different polarization states is carried out using the beam splitting element 106.

In particular, the aforementioned polarization states should be understood to mean linear polarization states, wherein for example two different polarization states are provided and/or polarization states oriented perpendicular to one another are provided.

In particular, the polarization states are such that an electric field is oriented in a plane perpendicular to the beam propagation direction of the polarized beams (transverse electric).

For the polarization beam splitting, the beam splitting element 106 comprises, for example, a birefringent lens element and/or a birefringent wedge element. For example, the birefringent lens element and/or the birefringent wedge element are made of a quartz crystal or comprise a quartz crystal.

With regard to the functionality and embodiment of the beam splitting element 106 as or with a polarization beam splitting element, reference is made to DE 10 2020 207 715 A1 and DE 10 2019 217 577 A1.

The beam splitting element 106 can be used to form in particular the sub-beams 116 with different polarization states. By focusing these sub-beams 116 using the focusing optical unit 118, it is possible to form the focus elements 120 in each case from beams having a specific polarization state. A specific polarization state may thus be assigned to each of the focus elements 120.

In particular, provision may be made for the focus elements 120 to be arranged and formed by polarization beam splitting using the beam splitting element 106 in such a way that mutually adjacent focus elements 120 each have different polarization states.

Coupling-in of the focus elements 120 into the material 102 takes place, for example, through a first outer side 132 of the material 102 of the workpiece 104. A second outer side 134 of the material 102 of the workpiece 104 is, for example, arranged spaced from the first outer side 132 in the thickness direction 126 of the workpiece 104.

The first outer side 132 and the second outer side 134 are, for example, oriented at least approximately parallel to one another. For example, the workpiece 104 is plate-shaped and/or panel-shaped.

The material 102 of the workpiece 104 has, for example, an at least approximately constant thickness D in the thickness direction 126.

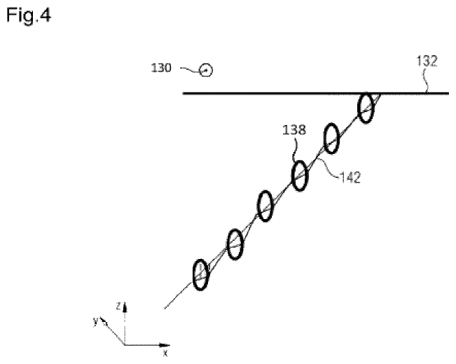

The focus elements 120 formed are arranged along the processing line 128. The respective spacings d and intensities I of the focus elements 120 arranged along the processing line 128 are selected such that, by applying these focus elements 120 to the material 102, material modifications 138 are formed (FIG. 4), so enabling severing of the material 102 along the processing line 128 and/or a processing surface corresponding to this processing line 128 using a wet chemical solution.

The respective spacing d of the focus elements 120 provided for laser processing of the workpiece 104 can be selected differently for different focus elements 120 and/or different pairs of focus elements 120. However, it is fundamentally also possible for the respective spacing d to be identical for all the focus elements 120 provided for laser processing of the workpiece 104.

In particular, a spacing component d_{z} of the spacing d oriented parallel to the thickness direction 126 of the material 102 is nonzero for all the focus elements 120 and/or in all pairs of mutually adjacent focus elements 120. In particular, all the adjacent focus elements 120 are spaced apart with a nonzero spacing component d_{z} in the thickness direction 126.

In the illustrations according to FIGS. 3 and 4, the focus elements and material modifications are shown merely schematically in terms of number, geometry, extent and arrangement.

In particular, provision may be made for the processing line 128 to extend between the first outer side 132 and the second outer side 134 of the workpiece 104 and in particular continuously and/or without interruption between the first outer side 132 and the second outer side 134.

Provision may be made for the processing line 128 to have multiple different portions 140. For example, in the example shown in FIG. 3, the processing line 128 has a first portion 140a, a second portion 140b, and a third portion 140c, wherein, with respect to the thickness direction 126, the second portion 140b adjoins the first portion 140a and the third portion 140c adjoins the second portion 140b.

The processing line 128 is not necessarily of regular and/or differentiable configuration. For example, the processing line 128 may have irregularities. Provision may be made for the processing line 128 to have interruptions and/or gaps, at which in particular no focus elements 120 are arranged.

The processing line 128 and/or the respective portions 140 of the processing line 128 are not necessarily straight. The processing line 128 and/or the portions 140 may be configured, for example, as a straight line or as a curve.

Furthermore, the processing line 128 and/or the respective portions 140 of the processing line 128 are assigned a given angle of attack a and/or angle of attack range, which the processing line 128 or the respective portion 140 forms with the first outer side 132 of the workpiece 104.

In the exemplary embodiment shown, the angle of attack a of the first portion 140a and the third portion 140c is 45° in terms of amount and that of the second portion 140b is 90°.

The material modifications 138 formed by applying and/or introducing the focus elements 120 into the material 102 are arranged in the material 102 at localized spatial positions. These spatial positions of the material modifications 138 correspond at least approximately to the spatial positions x₀, z₀ of the focus elements 120 in the material 102 by means of which the material modifications 138 were respectively formed. By suitable selection of processing parameters, such as the respective spacings d between the focus elements 120, their respective intensities I, a feed speed oriented in the feed direction 130, and the laser parameters of the input laser beam 108, the material modifications 138 may take the form, for example, of type III modifications, which are accompanied in particular by spontaneous formation of cracks 142 in the material 102 of the workpiece 104. In particular, cracks 142 are formed between mutually adjacent material modifications 138.

Provision is made for the material 102 of the workpiece 104 to be severed along the processing line 128 or along a processing surface corresponding to this processing line 128 by etching using a wet chemical solution.

For example, after the material modifications 138 have been formed, the workpiece 104 is introduced into the wet chemical solution for etching purposes, wherein the wet chemical solution penetrates through the first outer side 132 and/or the second outer side 134 into the material modifications 138 formed at the processing line 128 or processing surface and, where applicable, cracks 142 into the material 102.

FIG. 5 shows a simulated intensity distribution of a plurality of focus elements 120, wherein the spacing d is approximately 8.0 μm for these focus elements 120. In the grayscale value representation shown, lighter areas represent higher intensities.

The workpiece 104 is laser-processed as follows:

Using the device 100, focus elements 120 are formed for laser processing of the workpiece 104, for example by beam splitting the input laser beam 108 with the beam splitting element 106 and subsequent focusing of the sub-beams 116.

The focus elements 120 formed are applied to the material 102 of the workpiece 104 is, i.e., the focus elements 120 are introduced into the material 102, wherein the focus elements 120 are positioned along the predetermined processing line 128 in the material 102. The focus elements 120 are then moved through the material 102 in the feed direction 130 relative to said material 102.

In this case, the material 102 is a material transparent to a wavelength of laser beams from which the focus elements 120 are each formed, such as a glass material.

By applying the focus elements 120 to the material 102, material modifications 138 are formed in the material 102 at the respective positions of the focus elements 120 in the material 102.

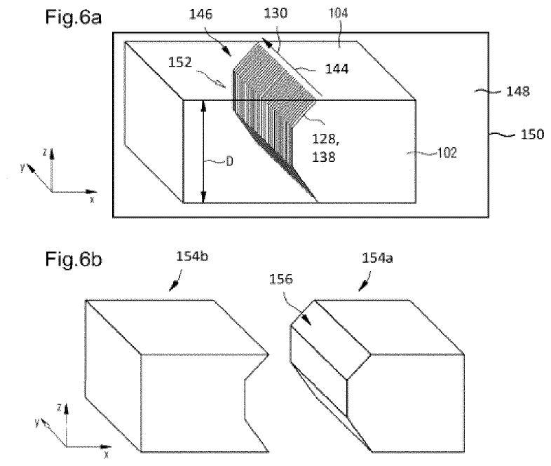

The material modifications 138 formed using the focus elements 120 are arranged along the processing line 128 (cf. FIGS. 3 and 6a), which extends, for example, continuously over the entire thickness D of the material 102. The focus elements 120 or material modifications 138 assigned to the processing line 128 define a cross-sectional geometry of the parting surface resulting from subsequent severing of the material (FIG. 6b).

The focus elements 120 are moved along a predetermined trajectory 144 relative to the material 102, whereby material modifications 138 arranged in planar manner are formed in the material 102. In the example shown in FIG. 6a, the trajectory 144 is oriented parallel to the feed direction 130.

By relative movement of the focus elements 120 in relation to the material 102 along the trajectory 144, a processing surface 146 corresponding to the processing line 128 is formed, on which the material modifications 138 are arranged. In particular, the processing line 128 lies in the corresponding processing surface 146.

The trajectory 144 may in principle have straight and/curved portions. In the case of curved portions, the processing line 128 is rotated during execution of the relative movement between material 102 and focus elements 120 in particular such that the processing line 128 always lies in a plane oriented perpendicular to the feed direction 130. This can be implemented, for example, by corresponding rotation of the beam splitting element 106 or by relative rotation of the entire device 100 in relation to the workpiece 104.

A spacing between material modifications 138 adjacent in the feed direction 130 may be defined, for example, by setting a pulse spacing for the laser pulses of the input laser beam 108 and/or by setting the feed speed.

The material modifications 138 formed along the processing line 128 or processing surface 146 result in a reduction in the strength of the material 102, wherein the strength is reduced in particular due to the cracks 142 formed.

Once the material modifications 138 have been formed in the material 102, an etching process is carried out with a wet chemical solution 148 to sever the material 102 along the processing line 128 and/or processing surface 146. For this purpose, the material 102 is, for example, partially or completely introduced into an etching bath 150 (indicated by the rectangle in FIG. 6a), which contains the wet chemical solution 148. In particular, the material 102 is partially or completely introduced into the wet chemical solution 148 such that the wet chemical solution 148 partially or completely surrounds the material 102. The subsequent etching process is carried out with the wet chemical solution 148 at a specific temperature and for a specific duration.

The wet chemical solution penetrates into the material modifications 138 and/or cracks 142 associated with the processing line 128 on the outer sides 132, 134 and then penetrates along the processing line 128 into an inner region 152 of the material 102. The inner region 152 is in particular a region of the material 102 that is spaced apart from the respective outer side 132, 134 parallel to the thickness direction 126.

In particular, etching using the etching bath 150 may be performed with ultrasound assistance.

The temperature of the wet chemical solution 148 is between 100° C. and 150° C. In particular, the temperature of the wet chemical solution 148 is kept at least approximately constant for the duration of the etching process, wherein a setpoint value for the temperature constant over time lies in the above value range. The etching process is carried out at a constant temperature of 130° C., for example.

With regard to the temperature of the wet chemical solution 148, “at least approximately constant” should preferably be understood to mean that an actual temperature of the wet chemical solution 148 deviates from the predetermined (constant over time) setpoint value by less than 7 K during the etching process.

The wet chemical solution is preferably an aqueous KOH solution or an aqueous NaOH solution, in each case with a concentration of between 15 wt. % and 50 wt. %.

The duration of the etching process for severing the material 102 depends on the type of material 102 as well as on the positioning and shape of the processing line 128 in the material 102. Typically the duration is between 5 minutes and 180 minutes.

By etching using the supplied wet chemical solution, the material 102 is severed at the processing surface 152 into two different workpiece segments 154a, 154b (FIG. 6b).

The workpiece segment 154b is a yield segment and/or a useful segment. It has a parting surface 156 which has a shape corresponding to the shape of the processing line 128 or processing surface 146.

In the example shown in FIG. 6b, the workpiece segment 154a is a reject segment and/or scrap segment.

The optimal parameters of the etching process, such as for example duration, the KOH or NaOH concentration of the wet chemical solution and its (constant over time) temperature, are specific to the respective material 102 of the workpiece 104 used.

Preferably, the parameters are selected such that during the etching process, the material 102 is etched at the material modifications 138 arranged along the processing line 128 or processing surface 152 at the higher speed and/or etching rate and at the same time the unmodified regions of the workpiece 104 are attacked as little as possible. The etching is therefore preferably carried out selectively at the material modifications 138 and/or cracks 142 formed in the material 102 with the higher etching rate. This makes it possible to carry out the etching process for severing the material 102 in the shorter time.

The material 102 of the workpiece 104 is quartz glass, for example. To form the material modifications 138 as type III modifications, a laser beam from which the focus elements 120 are formed then, for example, has a wavelength of 1030 nm and a pulse duration of 3 ps. Furthermore, a numerical aperture assigned to the focusing optical unit 118 is then 0.4 and a pulse energy assigned to a single focus element 120 is then 500 to 5000 nJ.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

a Angle of attack
d Spacing
d_{z} Spacing component
D Thickness
x₀ Position in the x direction
z₀ Position in the y direction
100 Device
102 Material
104 Workpiece
106 Beam splitting element
108 Input laser beam
110 Laser source
112 Beam cross-section
114 Wavefront
116 Sub-beams
116a Sub-beam
116b Sub-beam
118 Focusing optical unit
120 Focus element
121 Focus distribution
122 Beam forming device
124 Beam propagation direction
126 Thickness direction
128 Processing line
130 Feed direction
132 First outer side
134 Second outer side
138 Material modification
140 Portion
140a First portion
140b Second portion
140c Third portion
142 Crack
144 Trajectory
146 Processing surface
148 Wet chemical solution
150 Etching bath
152 Inner region
154a Workpiece segment/scrap segment
154b Workpiece segment
156 Parting surface

The invention claimed is:

1. A method for severing a workpiece having a transparent material, the method comprising:
providing multiple focus elements using an input laser beam,
applying the multiple focus elements to the material, thereby forming material modifications in the material along a predetermined processing line, and
severing the material along the processing line by an etching process using a wet chemical solution, wherein a temperature of the wet chemical solution during the etching process is at least 100° C. and/or at most 150° C.

2. The method according to claim 1, wherein the wet chemical solution is an aqueous KOH solution with a concentration of at least 15 wt. % and/or at most 50 wt. %.

3. The method according to claim 1, wherein the wet chemical solution is an aqueous NaOH solution with a concentration of at least 15 wt. % and/or at most 50 wt. %.

4. The method according to claim 1, wherein the temperature of the wet chemical solution is kept constant over time during the etching process.

5. The method according to claim 1, wherein the temperature is adjusted to a setpoint temperature that is constant over time, and wherein an actual temperature of the wet chemical solution during the etching process deviates from the setpoint temperature by less than 7 K.

6. The method according to claim 5, wherein the actual temperature of the wet chemical solution during the etching process deviates from the setpoint temperature by less than 1 K.

7. The method according to claim 5, wherein the wet chemical solution is an aqueous KOH solution or an aqueous NaOH solution, wherein a concentration of the solution is selected such that a boiling temperature of the solution is at least 5% higher than the setpoint temperature.

8. The method according to claim 1, wherein the etching process has a duration of at least 5 minutes and/or at most 180 minutes.

9. The method according to claim 1, wherein, to carry out the etching process, the wet chemical solution is applied to the material by introducing the material partially or completely into the wet chemical solution.

10. The method according to claim 1, wherein a spacing between adjacent focus elements is at least 3 μm and/or at most 70 μm, and/or a spacing between adjacent material modifications is at least 3 μm and/or at most 70 μm.

11. The method according to claim 1, wherein the input laser beam is a pulsed laser beam.

12. The method according to claim 11, wherein each focus element is assigned a pulse energy of at least 0.5 μJ and/or at most 10 μJ.

13. The method according to claim 1, wherein the input laser beam is split into a plurality of sub-beams using a beam splitting element, and the focus elements are formed by focusing the plurality of sub-beams coupled out of the beam splitting element.

14. The method according to claim 1, wherein the processing line is formed spatially continuously over a thickness of the material of the workpiece.

15. The method according to claim 1, wherein a spacing between adjacent focus elements has a nonzero spacing component, which is oriented parallel to a thickness direction of the workpiece.

16. The method according to claim 1, wherein an angle of attack between the processing line and an outer side of the workpiece through which the focus elements are coupled into the material of the workpiece is at least 1° and/or at most 90° at least in some places.

17. The method according to claim 1, wherein the material modifications are type III material modifications, and/or wherein the material modifications are accompanied by crack formation in the material.

18. The method according to claim 1, wherein the focus elements are moved relative to the material of the workpiece in a feed direction, and wherein the focus elements lie at least approximately in a plane oriented perpendicular to the feed direction.
